(19) United States
(12) Patent Application Publication
(10) Pub. No.: US 2011/0025584 A1
(43) Pub. Date: Feb. 3, 2011

(54) LIGHT-EMITTING DIODE HEADS-UP DISPLAY FOR A VEHICLE

(75) Inventors: RODRIGO K. NISHIGASAKO, SAO PAULO/SP (BR); JOAO CLAUDIO BRITO SANTOS, SANTA PAULA - SAO CAETANO DO SUL (BR); ROGERIO VOLLET, SAO BERNARDO DO CAMPO - SP (BR)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/511,136

(22) Filed: Jul. 29, 2009

(51) Int. Cl. G09G 3/30

(52) U.S. Cl. 345/76

(57) ABSTRACT

A display system for a vehicle is provided. The vehicle comprises a windshield and the display system comprises a substantially transparent organic light-emitting diode (OLED) display coupled to the windshield, the OLED display adapted to display information to an operator of the vehicle, and a control device coupled to the OLED display, the control device adapted to operate the OLED display to present information to the operator of the vehicle.

### TECHNICAL FIELD

Embodiments of the subject matter described herein relate generally to heads-up displays for vehicles. More particularly, embodiments of the subject matter relate to heads-up displays for vehicles using light-emitting diode displays.

### BACKGROUND

Information related to the operation of a vehicle is often presented to the operator using displays in the console of the vehicle. For example, such information as the speed of the vehicle, the gear in which the vehicle is operating, the fuel level, any maintenance or urgent indicators, is displayed on the dashboard, typically above the steering wheel for easy viewing by the operator. Such displays are located in a position to be quickly viewed by the operator, preferably diverting their attention from the surrounding environment for as little time as possible.

In some vehicles, a heads-up display (HUD) is used to present information to the vehicle's operator directly on the forward windshield of the vehicle. Accordingly, the operator does not have to divert his gaze off the road to discern the information. Rather, the information is present in the operator's field of view.

Current HUD systems for vehicles, such as automobiles, are based around laser systems, wherein a laser projects information onto the interior of the vehicle's windshield. Such projection systems can be bulky, complex, and expensive, and can require delicate and/or sophisticated components which can be additionally expensive to install and repair or replace.

### BRIEF SUMMARY

A display system for a vehicle is provided. The vehicle comprises a windshield and the display system comprises a substantially transparent organic light-emitting diode (OLED) display coupled to the windshield, the OLED display adapted to display information to an operator of the vehicle, and a control device coupled to the OLED display, the control device adapted to operate the OLED display to present information to the operator of the vehicle.

A windshield assembly for a vehicle is also provided. The windshield assembly comprises a first transparent glass layer, a second transparent glass layer, and an organic light emitting diode (OLED) display positioned between the first and second transparent glass layers.

Another display system for a vehicle is provided. The vehicle comprises a windshield and the display system comprises a film layer coupled to the windshield, and an organic light-emitting diode (OLED) display adapted to present information to an occupant of the vehicle; the OLED display positioned between the film layer and the windshield.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is an exterior view of an embodiment of a vehicle having an organic light-emitting diode (OLED) heads-up display (HUD);

FIG. 2 is an interior view of the embodiment of FIG. 1;

FIG. 3 is an embodiment of a windshield with various configurations of OLED HUDs;

FIG. 4 is an exploded perspective view of another embodiment of an OLED HUD; and

FIG. 5 is a side view of another embodiment of an OLED HUD.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components and with reference to operations, processing tasks, and functions that may be performed by various computing components or devices. In practice, one or more processor devices can carry out the described operations, tasks, and functions by manipulating electrical signals representing data bits at memory locations in the system memory, as well as other processing of signals. It should be appreciated that the various block components shown in the figures may be realized by any number of hardware, software, and/or firmware components configured to perform the specified functions. For example, an embodiment of a system or a component, such as a controller or system controller, may employ various integrated circuit components, e.g., memory elements, digital signal processing elements, logic elements, look-up tables, or the like, which may carry out a variety of functions under the control of one or more microprocessors or other control devices.

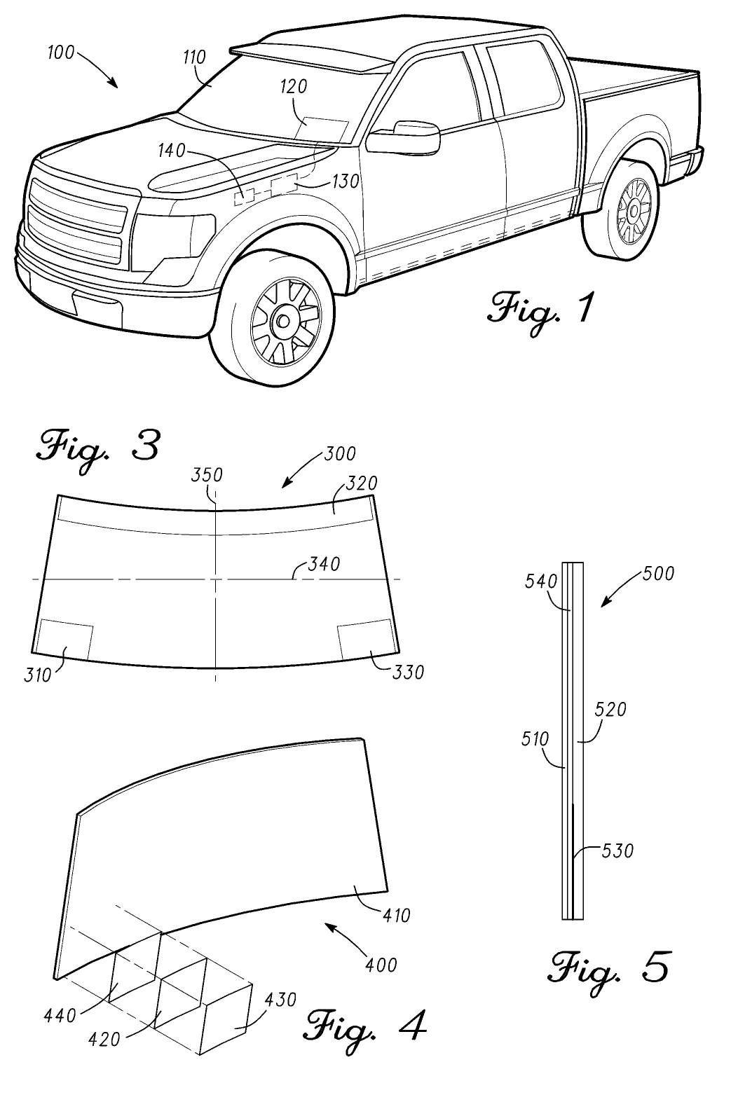

“Coupled”—The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the schematic shown in FIG. 1, for example, depicts one exemplary arrangement of elements, additional intervening elements, devices, features, or components may be present in an embodiment of the depicted subject matter.

“Adjust”—Some elements, components, and/or features are described as being adjustable or adjusted. As used herein, unless expressly stated otherwise, “adjust” means to position, modify, alter, or dispose an element or component or portion thereof as suitable to the circumstance and embodiment. In certain cases, the element or component, or portion thereof, can remain in an unchanged position, state, and/or condition as a result of adjustment, if appropriate or desirable for the embodiment under the circumstances. In some cases, the element or component can be altered, changed, or modified to a new position, state, and/or condition as a result of adjustment, if appropriate or desired.

FIG. 1 illustrates an embodiment of a vehicle 100 with a heads-up display (HUD) system including an organic light-emitting diode (OLED) display. The vehicle 100 has a front windshield 110 with an OLED HUD device 120. The OLED HUD device 120 is coupled to a controller 130. The controller 130 can be coupled to a variety of other components throughout the vehicle 100. One such component, a sensor 140 is illustrated for clarity. In practice, numerous and varied such components can be coupled to the controller 130.

The illustrated embodiment of vehicle 100 is an automobile. In practice, however, components and features of the systems described herein can be present in a wide variety of vehicles, such as aircraft, spacecraft, watercraft, and other land-based vehicles, such as motorcycles, construction equipment, scooters, and so on. Any type of vehicle with a transparent windscreen or windshield can practice certain aspects of the components and features described herein. For descriptive purposes, an automobile is used as an embodiment of the vehicle 100, other embodiments notwithstanding.

The front windshield 110 is coupled to the vehicle 100. The front windshield 110 can be positioned in a frame at the front of the passenger cabin, as shown. The front windshield 110 can be composed of any transparent or substantially transparent material, such as glass, including tempered glass, safety glass, shatter-proof glass or components, impact-resistant composites, and other types of transparent materials. As used herein, a transparent or substantially transparent object is one that visible light is permitted to pass through. Preferably, little to no visible light is obscured by the object, allowing a viewer to perceive the visible light. Transparency or substantial transparency does not require the object be complete clear, and tinting or shading of color is permissible, so long as a viewer can still perceive visible light through the object. Thus, a transparent windshield can be a clear glass windshield, or a shaded windshield, or a tinted windshield, and so on. Other types of electromagnetic radiation, such as ultraviolet light, can be inhibited from passing through a transparent object without interfering with visible light transmission.

Additionally, while “glass” is used to refer to one or more embodiments of the windshield, it should be understood that “glass” additionally refers to and includes those materials having the features and characteristics described above in reference to a transparent windshield. Thus, while silica-oxides can be used, other types of materials can also be used, including polymeric and silica-free glass, as well as others, without limitation. Thus, the term “glass”, as used herein, is not limited to any one specific material or type of material, and includes those which exhibit those characteristics described above.

The OLED HUD device 120 is a panel display device adapted to present information to an operator or occupant of the vehicle 100 by displaying visual images. The OLED HUD device 120 is preferably constructed using OLED techniques to produce graphical images recognizable to an occupant or operator of the vehicle 100. Such a display can be formed using multiple layers, such as an emissive layer, a conductive layer, a substrate, as well as anode and cathode terminals. The selection of materials and techniques for assembly the OLED HUD device 120 is preferably done to produce the described functionality and can vary between embodiments, although it preferably includes at least one layer produced from organic materials. Some exemplary materials which can be used include indium tin oxide for the anode terminal, as the transparent conductive oxide (TCO), tris(8-hydroxyquinolinato) aluminum molecules (Alq3) as an organic electroluminescent materials, and poly(p-phenylene vinylene) (PPV) as a polymeric electroluminescent material.

Additionally, although reference is made to a general OLED device, such structures and devices can be based on polymeric light-emitting diodes based on the usage of organic light-emitting materials, despite the structure, arrangement, or variation of materials. Thus, although “OLED” is used to refer to the light-emitting materials and device, it should be understood that any composition of light-emitting materials based on the use of organic materials is contemplated.

The OLED HUD device 120 can operate in one of several modes. For example, the OLED HUD device 120 can have an inoperative mode during which no visual images are displayed. The blank or unpowered inoperative mode of the OLED HUD device 120 is preferably transparent or substantially transparent. Preferably, an occupant or operator of the vehicle 100 can see through the OLED HUD device 120 without impairment in such a state. Accordingly, the OLED HUD device 120 preferably comprises appropriate components to present such an appearance, such as a clear or transparent substrate, anode terminal, cathode terminal, and so on.

The OLED HUD device 120 can display graphical images using one or more colors. For example, a red or green color can be displayed against the transparent components. In certain embodiments, a different color background can be displayed for contrast. In various embodiments, greater numbers of colors can be used without limitation, such as four-color OLED HUD devices, or an embodiment of the OLED HUD device which can display millions of colors, or more. The resolution or pixel count of the OLED HUD device 120 can similarly vary between embodiments, without deviating from the spirit of the functionality described herein.

The controller 130 can be any device adapted to operate the OLED HUD device 120 in a desired way. The controller 130 can be the general vehicle controller, or a sub-controller component which interoperates with the general vehicle controller. The controller 130 can be physically integrated with other devices, such as another controlling or system operating device. The controller 130 need not be physically distinct from other components to perform the described features and functions.

The controller 130 is preferably coupled to the OLED HUD device 120 and other components of the vehicle as appropriate for operation of the features described. The controller 130 can receive signals from other components, such as the sensor 140, and can be coupled to other devices and/or components of the vehicle, if desired. The controller 130 can additionally transmit signals conveying information and instructions to components to which it is coupled. For example, the controller 130 can receive signals from the sensor 140 and make use of information conveyed in the signals. The controller 130 can operate the OLED HUD device 120 to produce varying visual images in response to received signals, as well as controlling the operative states of the OLED HUD device 120.

The sensor 140 can be any sensor, such as a speed sensor which detects the speed of the vehicle, a light sensor, such as a camera or other light-sensitive device, an accelerometer, a GPS position sensor, and so on, without limitation. Although one sensor 140 is shown, multiple can be present in different embodiments, all coupled to the controller 130, or to a component coupled to the controller 130, providing information therethrough. Additionally, in different embodiments, the sensors can be from one or more type providing different information to the controller 130. For example, a single controller 130 can be coupled to each of the listed sensor types, as well as other sensor types, such as temperature sensor adapted to detect the temperature of one or more components in the engine, or a fuel sensor adapted to detect the amount of fuel remaining on board the vehicle, and so on. Thus, while one sensor 140 is illustrated for clarity and described, any type or combination of sensors can be used when desired or appropriate.

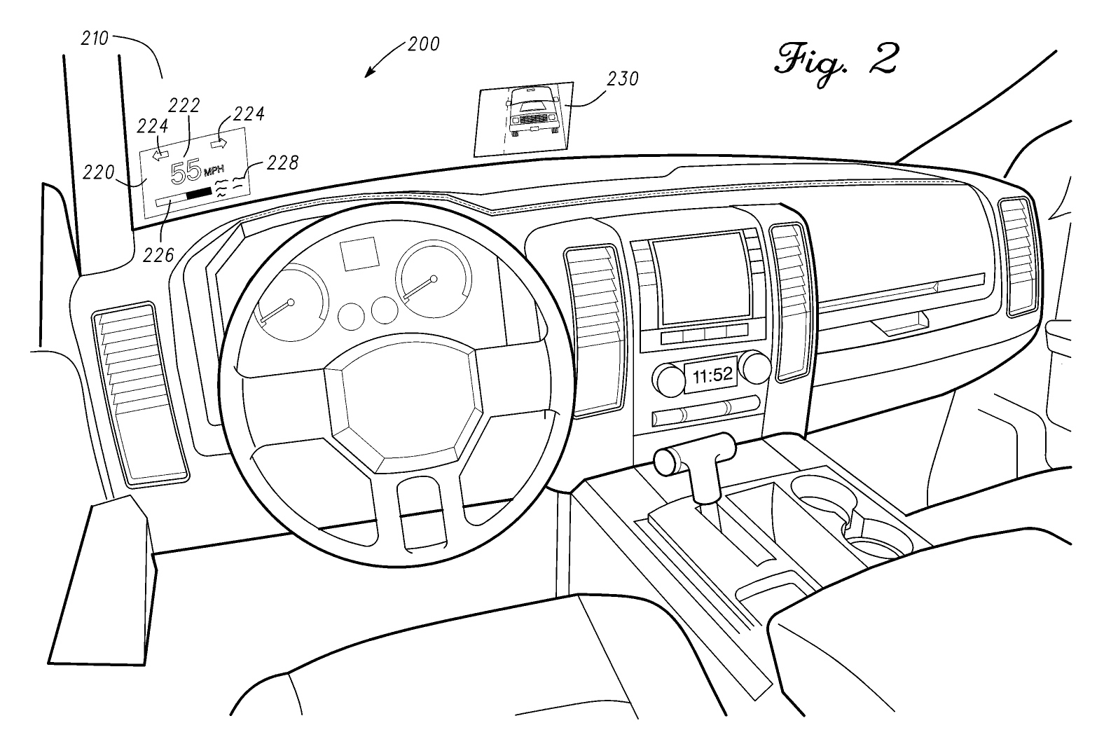

FIG. 2 illustrates a view of the front windshield 210 of a vehicle 200 with another embodiment of an OLED HUD display. A first OLED HUD device 220 is positioned on the front windshield 210 to the left of the steering wheel of the vehicle 200. A second OLED HUD device 230 is positioned to the right of the steering wheel of the vehicle 200. As shown, more than one OLED HUD device can be present in or on or coupled to any windshield, as desired for the embodiment. Although two such devices are illustrated in FIG. 2, other embodiments can have more or fewer, as desired or appropriate. Each OLED HUD display device can be coupled to one or more controllers, as previously described.

Certain exemplary visual images are illustrated as present in the first OLED HUD device 220, which can be useful to the operator or occupant. For example, the speed indicator 222 can be used to represent the speed of the vehicle in miles per hour, kilometers per hour, or any other units. Additional images, such as turn indicator images 224 can flash when the turn signal for a particular direction is engaged, or a fuel level gauge 226, or engine status information indicators 228, can also be displayed. The selection of images to display, as well as technique for displaying them, can vary between embodiments. As just one example, the fuel level gauge 226 can be a graphical representation, or a percentage indicator, or an estimate of the number of miles or kilometers which can be travelled on the remaining fuel, and so on. Each indicator can be formed using different colors or shapes, as desired. For example, a graphical representation of the fuel level gauge 226 can be colored green while the fuel level is above a predetermined level. After the fuel level drops below the predetermined level, the fuel level gauge 226 can be displayed in red, to attract the attention of the operator of the vehicle 200. Other presented information can similarly vary in representation, color, shape, and size, according to the embodiment.

The second OLED HUD device 230 illustrates a rear view from the vehicle 200. The second OLED HUD device 230, therefore, displays a video image from a rear-looking video sensor. The second OLED HUD device 230 can be positioned in any desired location. The video image can have any desired frame rate. The second OLED HUD device 230 can include additional information together with the video image, such as information indicating the distance an object, such as another automobile, is following the automobile containing the second OLED HUD device 230. Additionally or alternatively, the second OLED HUD device 230 can receive information for different sensors, such as a side-looking camera to aid in parallel parking. In certain embodiments, information from a radar sensor can be presented to an operator to assist the operator in detecting unseen objects, such as a person or automobile moving toward the rear of the vehicle, the view of which may be obstructed from the operator's position.

In addition to the features and/or functions described above, in certain embodiments of the OLED HUD devices can be configured to adjust their function, thereby presenting new or different information as instructed by a user of the system. Thus, while one example of certain displayed information is shown, the visual images can be shown on different display devices, or different information altogether can be shown.

Moreover, additional features can be combined with the display features to augment the functionality of the OLED HUD display devices. For example, a touchscreen device can overlay some or all of the OLED HUD display device, thereby permitting input to as well as output from the controller directly at the display location.

FIG. 3 illustrates a variety of OLED HUD devices 310, 320, 330 of varying sizes and shapes positioned at a variety of locations in and/or on a windshield 300. The first OLED HUD device 310 is positioned at the bottom left of the windshield 300, while the second OLED HUD device 320 is positioned across the top of the windshield 300, stretching substantially along the entire width of the windshield 300. The third OLED HUD device 330 is positioned at the bottom right of the windshield 300. Other OLED HUD devices can be differently sized and positioned at any desired position on the windshield 300.

A windshield, such as windshield 300 can be described as having four quadrants described by bisecting horizontal and vertical lines 340, 350. As shown, an OLED HUD device can be positioned in a single quadrant, such as the first OLED HUD device 310 positioned in the lower left quadrant. Alternatively, in some embodiments, an OLED HUD device can extend across more than one quadrant, such as the second OLED HUD device 320, which extends across both the top left and top right quadrants.

Although previously described as a forward windshield for illustrative purposes, rear and side transparent panels, such as a rear windshield or side window, can be similarly prepared to present information with an OLED HUD display device positioned thereon.

FIG. 4 illustrates an exploded view of one exemplary OLED HUD display assembly 400. The OLED HUD device 420 is coupled to an interior surface of the windshield 410 through the use of additional components. An adhesive layer 440 can be disposed between the OLED HUD device 420 and the windshield 410. Additionally, or instead of the adhesive layer 440, a film layer 430 can overlay the OLED HUD device 420 and couple to at least a portion of the windshield 410. Either or both of the adhesive layer 440 and/or film layer 430 can be transparent or substantially transparent, if desired. Moreover, either can have artifacts or coloration which interoperate with the OLED HUD device 420 to produce desired visual images, such as a background.

Accordingly, in some embodiments, the OLED HUD device 420 can be directly affixed to the windshield 410 by the adhesive layer 440. In those embodiments where the windshield 410 has a curvature beyond a flat pane, the OLED HUD device 420 can have flexible characteristics which permit it to conform to the contours of the windshield 410. In alternative embodiments, the OLED HUD device 420 can have a conformal shape without the necessity of flexible characteristics. On other embodiments, the film layer 430 can be affixed to the windshield 410 with the OLED HUD device 420 inserted therebetween. In such embodiments, the film layer 430 can itself comprise an adhesive or bonding agent. In some embodiments, the film layer 430 can have a different size, such as overlaying the entirety of the windshield 410, or any portion thereof, to couple the OLED HUD device 420 to the windshield 410. In some embodiments, the combination of all illustrated components can be practiced to couple the OLED HUD device 420 to the windshield 410. In those embodiments of OLED HUD display assemblies with multiple OLED HUD display devices, the same or different techniques for coupling them to the windshield can be used.

FIG. 5 illustrates a side view of an embodiment of an exemplary OLED HUD display assembly 500. As shown, another technique for coupling an OLED HUD device 530 to a windshield can be to position the OLED HUD device 530 between first and second windshield layers 510, 520. A transparent film 540 can additionally be positioned between the windshield layers 510, 520 and coupled to the OLED HUD device 530. The transparent film 540 can be made of a polymeric material, but can be of any desired or appropriate material. The transparent film 540 can have adhesive or bonding properties to contribute to coupling of the windshield layers 510, 520.

The OLED HUD device 530 is preferably positioned at the desired location between the windshield layers 510, 520, which are subsequently coupled together, which can include the use of the transparent film 540. Accordingly, the OLED HUD device 530 is held in place in the completed assembly 500. No matter the technique for coupling the OLED HUD display device(s) to a windshield or other transparent panel on a vehicle, any necessary or desired connections or coupling between the OLED HUD display device(s) and a controller or other component are maintained, such as through trace connection devices extending through or on the windshield. Any such connection elements can be assembled using the same or similar technique to that used for the OLED HUD display device(s).

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A display system for a vehicle comprising a windshield, the display system comprising:
a substantially transparent organic light-emitting diode (OLED) display coupled to the windshield, the OLED display adapted to display information to an operator of the vehicle; and
a control device coupled to the OLED display, the control device adapted to operate the OLED display to present information to the operator of the vehicle.

2. The display system of claim 1, wherein the windshield comprises a first transparent glass layer and a second transparent glass layer, and the OLED display is positioned between the first and second transparent glass layers.

3. The display system of claim 1, further comprising an adhesive layer adapted to couple the OLED display to the windshield.

4. The display system of claim 1, wherein the windshield has an exterior surface and an interior surface and the OLED display is conformally coupled to the interior surface.

5. The display system of claim 1, further comprising a sensor coupled to the control device, the sensor adapted to detect a condition of operation of the vehicle and transmit a signal to the control device, the signal conveying information regarding the condition of operation of the vehicle.

6. The display system of claim 5, wherein the sensor comprises a vehicle speed sensor, and the condition of operation comprises a speed of the vehicle.

7. The display system of claim 6, wherein the control device is further adapted to operate the OLED display to present the speed of the vehicle to the operator.

8. The display system of claim 1, wherein the windshield has a wide dimension having a width and the OLED display extends substantially across the width of the windshield.

9. A windshield assembly for a vehicle comprising:
a first transparent glass layer;
a second transparent glass layer; and
an organic light emitting diode (OLED) display positioned between the first and second transparent glass layers.

10. The windshield assembly of claim 9, wherein the OLED display has a first operating state and a second operating state, and the OLED display is adapted to be substantially transparent in the first operating state and display information in the second operating state.

11. The windshield assembly of claim 9, wherein the OLED display is adapted to display at least two different colors.

12. The windshield assembly of claim 9, wherein the windshield assembly has an interior surface, and the OLED display is adapted to present information toward the interior surface.

13. The windshield assembly of claim 9, further comprising a controller coupled to the OLED display, the controller adapted to operate the OLED display to present information to an operator of the vehicle.

14. The windshield assembly of claim 9, wherein the windshield assembly has two upper quadrants and two lower quadrants, and the OLED display is positioned in one of the two lower quadrants of the windshield assembly.

15. The windshield assembly of claim 9, wherein the windshield assembly is a rear windshield for the vehicle.

16. The windshield assembly of claim 9, further comprising a transparent film positioned between the first and second transparent glass layers, the transparent film adapted to adhere to the first and second transparent glass layers.

17. A display system for a vehicle comprising a windshield, the display system comprising:
a film layer coupled to the windshield; and
an organic light-emitting diode (OLED) display adapted to present information to an occupant of the vehicle; the OLED display positioned between the film layer and the windshield.

18. The display system of claim 17, wherein the film layer is substantially transparent.

19. The display system of claim 17, wherein the film layer comprises an adhesive.

20. The display system of claim 17, wherein the film layer and OLED display are coupled to a rear windshield of the vehicle.
